(19) United States
(12) Patent Application Publication
(10) Pub. No.: US 2016/0233591 A1
(43) Pub. Date: Aug. 11, 2016

(54) CRIMP TERMINAL

(71) Applicant: YAZAKI CORPORATION, Tokyo (JP)

(72) Inventor: Takaya Kondou, Shizuoka (JP)

(73) Assignee: YAZAKI CORPORATION, Tokyo (JP)

(21) Appl. No.: 15/029,272

(22) PCT Filed: Oct. 16, 2014
(86) PCT No.: PCT/JP2014/077487

§ 371 Date: Apr. 14, 2016

(30) Foreign Application Priority Data
Oct. 18, 2013 (JP) 2013-216974

(51) Int. Cl. H01R 4/18

(52) U.S. Cl. CPC H01R 4/188; H01R 4/185

(57) ABSTRACT

A crimp terminal including a core-wire crimping section (16) for crimping a core wire of an electric wire including a plurality of strands includes serrations (18a, 18b) provided on a surface where the core wire of the core-wire crimping section (16) is to be crimped, small serrations (18b) are provided in a region to which a large crimping force is applied during a swaging and crimping process, and large serrations (18a) are provided in a region to which a small crimping force is applied.

### TECHNICAL FIELD

The present invention relates to a crimp mating terminal to an electric wire.

### BACKGROUND ART

Various types of crimp terminals provided with serrations on a crimping surface have been suggested in the past (e.g., refer to Patent Literature 1). Such a crimp terminal of a conventional example is illustrated in FIGS. 6 to 8. In FIGS. 6 to 8, an electric wire W connecting a crimp terminal 110 includes a core wire 101 including a plurality of strands 101a, and an insulation outer skin 102 covering an outer circumference of the core wire 101. At a tip side of the electric wire W, the insulation outer skin 102 is removed and, thus, the core wire 101 is exposed.

The crimp terminal 110 includes a mating terminal connection section 111 and an electric-wire connection section 115. The electric-wire connection section 115 includes a core-wire crimping section 116 and an outer-skin crimping section 117. The core-wire crimping section 116 includes a base-bottom section 116a and a pair of swaging piece sections 116b extended from both sides of the base-bottom section 116a. On inner surfaces of the base-bottom section 116a of the core-wire crimping section 116 and the pair of swaging piece sections 116b, a number of serrations 118 that are circular recessed sections are formed. The serrations 118 all having a same dimension are arranged almost all over the inner surface of the core-wire crimping section 116. The outer-skin crimping section 117 includes a base-bottom section 117a and a pair of swaging piece sections 117b extended from both sides of the base-bottom section 117a.

In the crimp terminal 110, the exposed core wire 101 is swaged and crimped by the core-wire crimping section 116, and the insulation outer skin 102 is swaged and crimped by the outer-skin crimping section 117.

### CITATION LIST

### Patent Literature

Patent Literature 1: Japanese Patent Laid-Open Publication No. 2009-123623

### SUMMARY OF INVENTION

### Technical Problem

However, during a swaging and crimping process of the core-wire crimping section 116, crimping forces applied to the core-wire crimping section 116 are not uniform all over the regions. In other words, as illustrated in FIGS. 9(a), 9(b) and 9(c), there are a “region to which a large crimping force is applied” and a “region to which a small crimping force is applied” on the core-wire crimping section 116.

FIG. 9(a) is a vertical cross-sectional view (cross-sectional view of a face parallel to an axial direction of the core wire 101) schematically illustrating a direction in which forces from a swaging jig is applied and illustrating only the core-wire crimping section 116. As illustrated in FIG. 9 (a), depending on a relative positional relationship from both ends of the core-wire crimping section 116 in the axial direction of the core wire 101, there are regions F0 and F2 where the forces from the swaging jig are concentrated during the swaging and crimping process on the core-wire crimping section 116. Further, in addition to the regions F0 and F2, there is a region F1 where forces applied between the core wire 101 and the core-wire crimping section 116 become stronger more than necessary. Positions of the regions F0, F1, and F2 are determined depending on a shape of the core-wire crimping section 116 and material of the core wire 101 and the like. The regions F0, F1 and F2 correspond to the “region to which a large crimping force is applied” described above. Further, the regions other than the regions F0, F1, and F2 on the core-wire crimping section 116 correspond to the “region to which a small crimping force is applied” described above.

As illustrated in FIGS. 9(b) and 9(C), serrations 118 provided in the “region to which a small crimping force is applied” have almost no stretch caused by rolling in local regions and keep a circular shape in a same size. However, serrations 118 provided in the “region to which a large crimping force is applied” are deformed into an oval shape due to large stretch caused by the rolling. As described above, when a size of the serrations 118 is changed, edges of the serrations 118 cannot be effectively used with respect to the stretch of the core wire 101, thereby suppressing the stretch of the core wire 101. Thus, there used to be a problem in which, since adhesion among the respective strands 101a cannot be efficiently obtained, conduction characteristics between the strands 101a are not improved and, thus, electric resistance at crimping positions is increased.

The present invention has been made for solving the above-described problems, and an object is to provide a crimp terminal in which the electric resistance at the crimping position of the electric wire can be reduced.

### Solution to Problem

A crimp terminal of the present invention is a crimp terminal including a core-wire crimping section for crimping a core wire of an electric wire including a plurality of strands, wherein first serrations are provided in a first region of the core-wire crimping section on a surface onto which the core wire is to be crimped, and wherein second serrations smaller than the first serrations are provided in a second region of the core-wire crimping section on the surface onto which the core wire is to be crimped, and to which a crimping force larger than that in the first region is applied during a swaging and crimping process.

In the crimp terminal according to the present invention, the first serrations or the second serrations may be circular recessed sections.

### BRIEF DESCRIPTION OF DRAWINGS

FIG. 1 is a perspective view of a crimp terminal before an electric wire is crimped thereto of an embodiment according to the present invention.

FIGS. 2(a), 2(b) and 2(c) illustrate an embodiment according to the present invention, in which FIG. 2(a) is a side view of the crimp terminal onto which the electric wire is crimped, FIG. 2(b) is a vertical cross-sectional view of a core-wire crimping section, and FIG. 2(c) is a cross-sectional view taken along a line A-A in FIG. 2 (a).

FIGS. 3(a), 3(b) and 3(c) illustrate an embodiment according to the present invention, in which FIG. 3(a) is a vertical cross-sectional view of the core-wire crimping section that schematically illustrates a direction in which a force from a swaging jig is applied, FIG. 3(b) is an exploded view of the core-wire crimping section before crimping, and FIG. 3(c) is an exploded view of the core-wire crimping section after the crimping.

FIG. 4 is a perspective view of a swaging jig of an embodiment according to the present invention

FIG. 5 is a side view illustrating a swaging work with the swaging jig of the embodiment according to the present invention.

FIG. 6 is a perspective view of the crimp terminal before the electric wire is crimped thereto according to a conventional example.

FIG. 7 is a side view of the crimp terminal to which the electric wire is crimped according to the conventional example.

FIG. 8 is a cross-sectional view taken along a line of B-B in FIG. 7 according to the conventional example.

FIGS. 9(a), 9(b) and 9(c) illustrate the conventional example, in which FIG. 9(a) is a vertical cross-sectional view of only the core-wire crimping section that schematically illustrates a direction in which a force from a swaging jig is applied, FIG. 9(b) is an exploded view of the core-wire crimping section before crimping, and FIG. 9(c) is an exploded view of the core-wire crimping section after the crimping.

### DESCRIPTION OF EMBODIMENTS

With reference to figures, an embodiment according to the present invention will be described below.

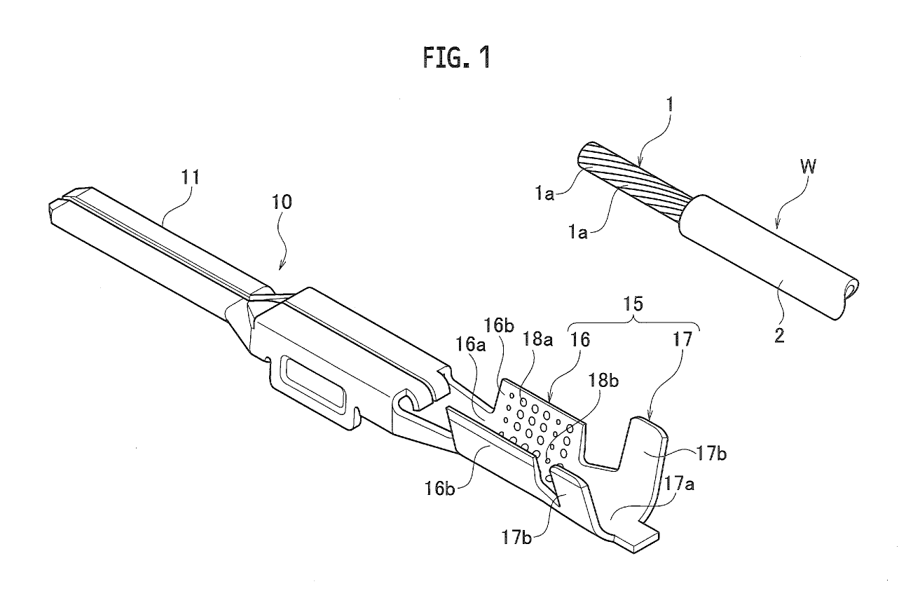

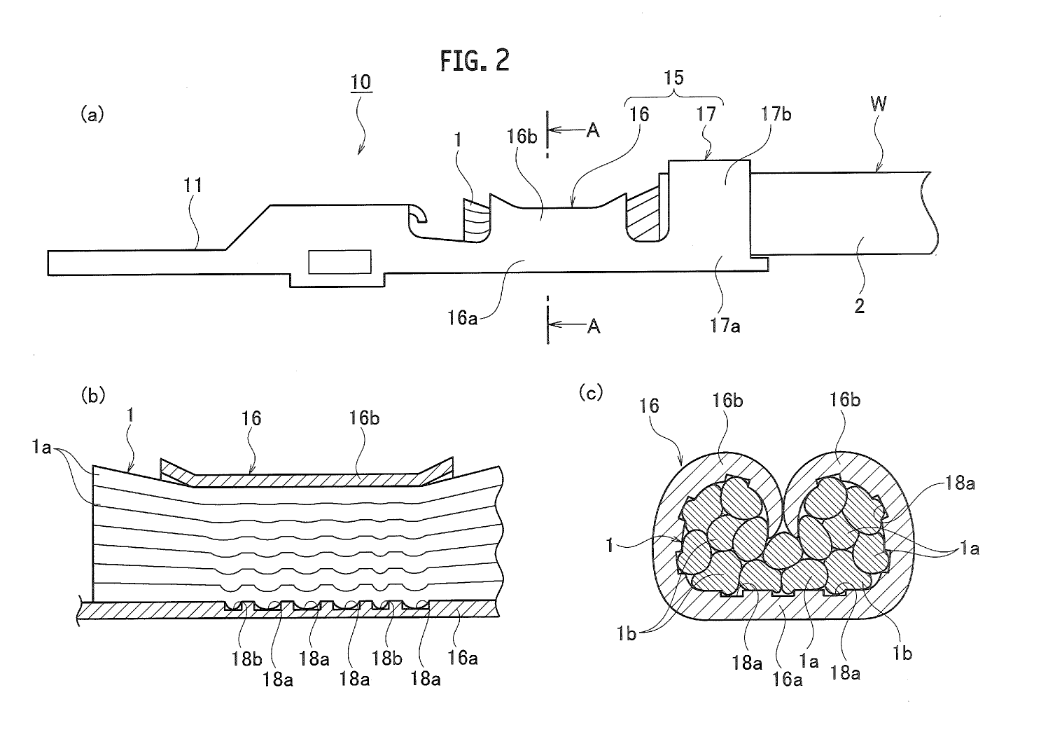

FIGS. 1 to 5 illustrate the embodiment according to the present invention. As illustrated in FIGS. 1 and 2, the electric wire W includes a core wire 1 including a plurality of strands 1a and an insulation outer skin 2 covering an outer circumference of the core wire 1. At a tip side of the electric wire W, the insulation outer skin 2 is removed and, thus, the core wire 1 is exposed. The core wire 1 includes a number of strands 1a made of aluminum or aluminum alloy (hereinafter referred to as “made of aluminum,” and a number of the strands 1a are twisted with each other. In other words, the electric wire W is an aluminum electric wire.

The crimp terminal 10 is, for example, made of copper alloy and formed by bending a plate cut into a predetermined shape. The crimp terminal 10 includes a mating terminal connection section 11 and an electric-wire connection section 15. The electric-wire connection section 15 includes a core-wire crimping section 16 and an outer-skin crimping section 17.

The core-wire crimping section 16 includes a base-bottom section 16a and a pair of swaging piece sections 16b extended from both sides of the base-bottom section 16a. On inner surfaces of the base-bottom section 16a of the core-wire crimping section 16 and the pair of swaging piece sections 16b (surfaces onto which the core wire 1 is crimped), a number of the serrations 18a, 18b that are a number of circular recessed sections are provided in a dotted manner almost all over the region. Configurations of the serrations 18a, 18b will be described in detail below.

The outer-skin crimping section 17 includes a base-bottom section 17a and a pair of swaging piece sections 17b extended from both sides of the base-bottom section 17a.

In the crimp terminal 10, the exposed core wire 1 is swaged and crimped by the core-wire crimping section 16, and the insulation outer skin 2 is also swaged and crimped by the outer-skin crimping section 17.

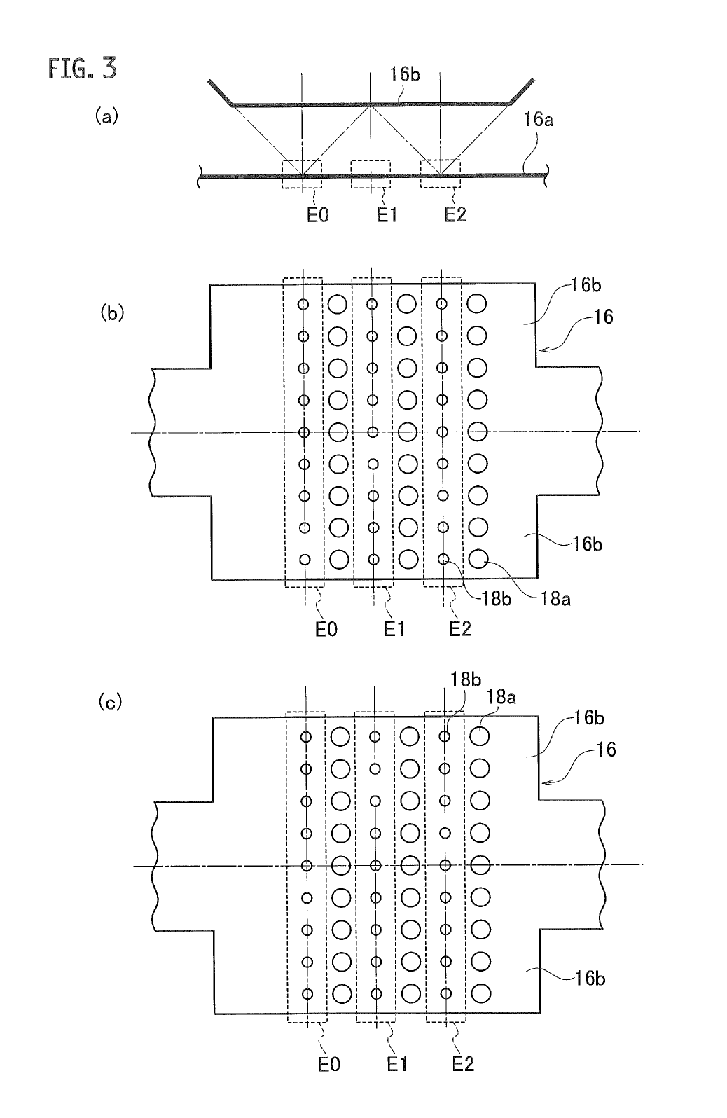

Subsequently, the serrations 18a, 18b will be described. As illustrated in FIG. 3(b), the serrations 18a, 18b are provided at almost equal intervals along an axial direction of the core wire 1 almost all over the region on the inner surface of the core-wire crimping section 16. The serrations 18a, 18b are circular recessed sections. The serrations 18a, 18b are provided such that the large serrations 18a (first serrations) are arranged in a region to which a small crimping force is applied during the swaging process, and a small serrations 18b (second serrations) are arranged in a region to which a large crimping force is applied during the swaging process.

The large serrations 18a (first serrations) are larger in a size than the small serrations 18b (second serrations). A size of the serrations refers to a diameter of the serrations or a depth thereof.

As illustrated in FIG. 3(a), the regions to which the large crimping force is applied during the swaging process are regions E0, E2 about a position where an auxiliary extending line at an angle of 45 degrees from both end positions of a swaging jig 20 intersects with the base-bottom section 16a. The small serrations 18b are provided in the regions E0, E2. Further, in addition to the regions E0, E2, there is a region E1 where forces applied between the core wire 1 and the core-wire crimping section 16 become stronger more than necessary. When the core wire 1 is made of aluminum as in the present embodiment, compared to the core wire 1 made of the copper alloy, the core wire 1 is further overly crimped in the region E1. In the region E1 also, the small serrations 18b are provided. The positions of the regions E0, E1, E2 are determined depending on a shape of the core-wire crimping section 16 and material of the core wire 1.

Of the surfaces of the core-wire crimping section 16 onto which the core wire 1 is crimped, in the regions other than the regions E0, E1, E2, the small crimping forces are applied during the swaging process and, thus, the large serrations 18a are provided.

Of the surfaces of the core-wire crimping section 16 onto which the core wire 1 is crimped, the regions other than the regions E0, E1, E2 are the “region to which a small crimping force is applied” (first regions). Of the surfaces of the core-wire crimping section 16 onto which the core wire 1 is crimped, the regions indicated with the regions E0, E1, E2 correspond to the “region to which a large crimping force is applied”(second regions). The crimping force applied to the first region is smaller than that applied to the second region.

In other words, of the surfaces of the core-wire crimping section 16 onto which the core wire 1 is crimped, in the regions other than the regions E0, E1, E2 (first regions), the serrations 18a (first serrations) are provided. On the other hand, in the regions E0, E1, E2 (second regions) to which the larger crimping force is applied compared to the regions other than the regions E0, E1, E2 during the swaging and crimping process, the serrations 18b (second serrations) are provided.

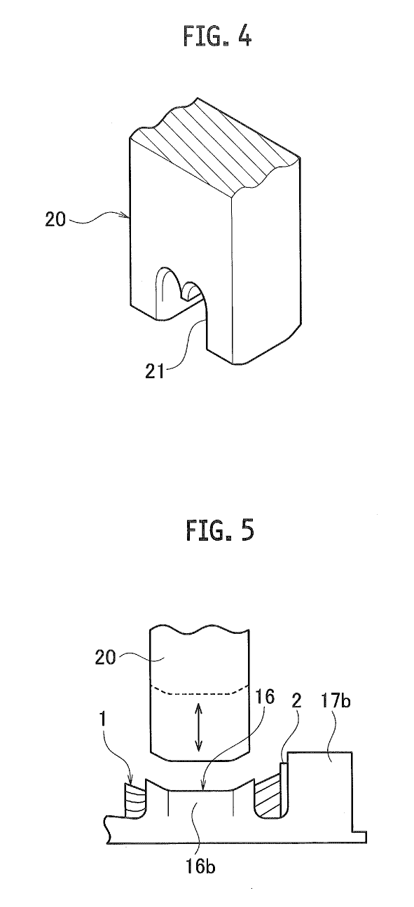

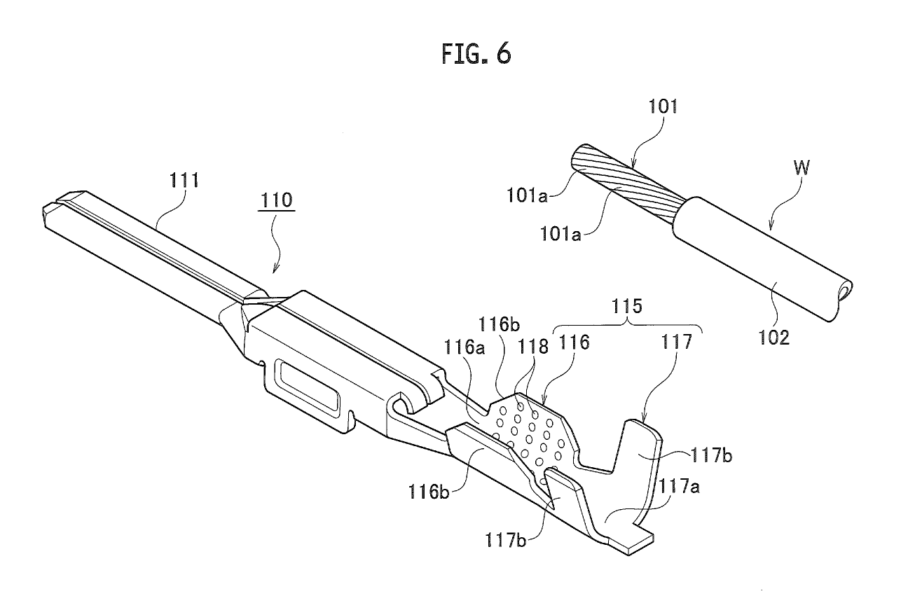

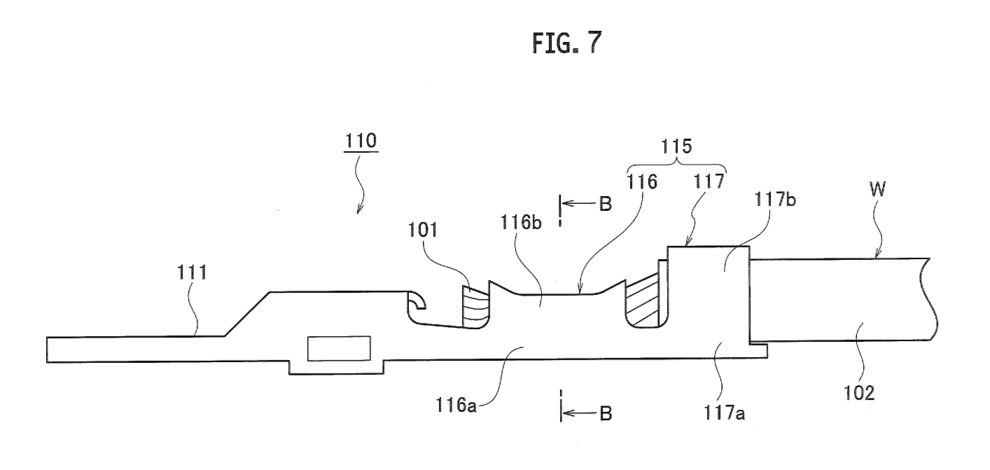

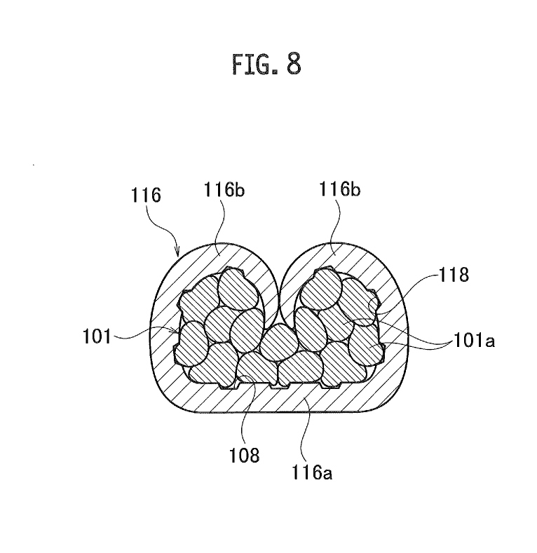

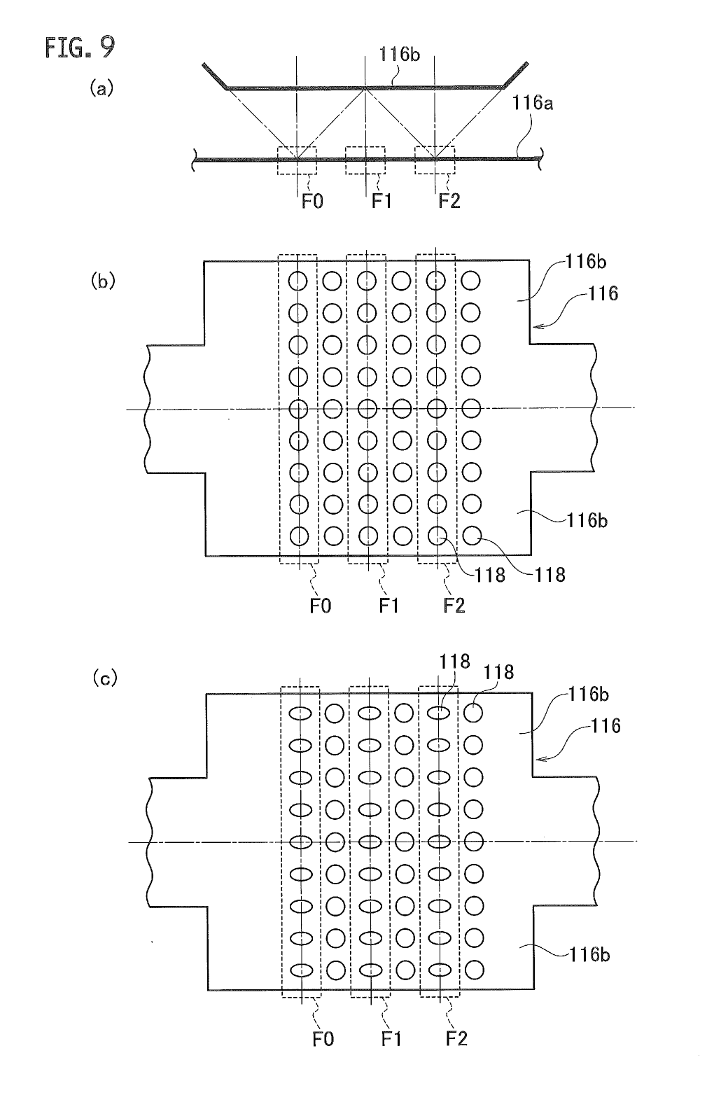

The crimp terminal 10 is crimped by the swaging jig 20 illustrated in FIG. 4. The swaging jig 20 includes a swaging groove 21 having an outer circumferential shape of final swaging at a swaging tip side. As illustrated in FIG. 5, when the pair of core-wire swaging piece sections 16b are pressed from above by the swaging jig 20, the pair of swaging piece sections 16b are plastic-deformed along the swaging groove 21.

During the swaging and crimping process, the core wire 1 receives the crimping forces from the core-wire crimping section 16 and, accordingly, each of the strands 1a of the core wire 1 gets into the serrations 18a, 18b so that the strands 1a is stretched to generate a newly born surface.

Further, during the swaging and crimping process, the large crimping force is applied to the regions E0, E1, E2 (second regions) including the small serrations 18b (second serrations). However, since the regions E0, E1, E2 (second regions) include a large thick region (region other than serrations 18b), almost no stretch is generated by the rolling, and thus deformation of the serrations 18b can be suppressed.

On the other hand, in the regions of the large serrations 18a (first serrations), in other words, in the regions (first regions) other than the regions E0, E1, E2, since only small crimping force is applied, even if there is the large thin region (the region of the serrations 18a), almost no stretch is generated by the rolling, and thus the serrations 18a are not deformed.

As described above, since the deformation of the serrations 18a, 18b can be suppressed, edges of the serrations 18a, 18b can be effectively used with respect to the stretch of the core wire 1 to promote the stretch thereof. With this arrangement, the adhesion among the strands 1a can be efficiently obtained to improve the conduction characteristics between the strands 1a, thereby reducing the electric resistance at the crimping point.

Further, since the each of the strands 1a gets into the serrations 18a, 18b, tensile strength between the core wire 1 and the core-wire crimping section 16 can be improved (mechanical strength is improved).

As described above, design of a part of the crimp terminal 10 is changed (size change of the serrations) to improve the conduction characteristics of the core wire 1 at the crimping point. Therefore, the electric resistance at the crimping point can be reduced without raising costs compared to making the core wire into a single line.

The core wire 1 is made of aluminum. An oxidized film produced on a surface of the strands 1a and made of the aluminum is harder compared to that of the copper alloy. Therefore, the core wire 1 made of the aluminum used to have a problem of an increase of the electric resistance due to the conduction resistance between the strands 1a. However, according to the present invention, since the conduction resistance between the strands 1a can be reduced, the present invention is effective particularly for the aluminum electric wire. The core wire 1 made of aluminum is softer and stretched more easily compared to that made of copper alloy. However, as described above, since stress transferring loss from the core-wire crimping section 16 to the core wire 1 can be reduced, the present invention is effective particularly for the aluminum electric wire also from this point of view.

According to the embodiment, the serrations 18a, 18b are the circular recessed sections, however, of course, they may be recessed sections having other shapes (oval, triangle, square (including diamond), polygonal shape including more than four sides, and a star-like shape).

According to the embodiment, the core wire 1 is made of aluminum, however, the present invention can be applied to the core wire 1 made of material other than aluminum (e.g., made of copper alloy). When the core wire is made of copper alloy, the serrations provided in the region E1 illustrated in FIG. 3(b), FIG. 3(c) are made in a large size.

The embodiment according to the present invention described as above is only an example described for easier understanding of the present invention, and the present invention is not limited to the embodiment described above. The technical aspect of the present invention is not limited to specific technical items disclosed in the above described embodiment, but include various changes, modifications, and alternative techniques that can be easily directed from the above described embodiment.

The present application claims the priority based on Japanese Patent Application No. 2013-216974 filed on the Oct. 18, 2013, and the whole contents of the application are incorporated into the present specification as reference.

### INDUSTRIAL APPLICABILITY

According to the present invention, during the swaging and crimping process, the large crimping force is applied to the region of the small serrations. However, since the thin region (other region of small serrations) is large, almost no stretch is generated by the rolling, and thus deformation of the serrations can be suppressed. On the other hand, in the region of the large serrations, since only small crimping force is applied, even if the thin region (region of the large serrations) is large, almost no stretch is generated by the rolling, and the serrations are not deformed. As described above, since the deformation of the serrations can be suppressed, the edges of the serrations can be effectively used with respect to the stretch of the core wire, thereby promoting the stretch of the core wire. With this arrangement, the adhesion among the strands can be efficiently obtained to improve the conduction characteristics between the strands, thereby reducing the electric resistance at the crimping point.

### REFERENCE SIGNS LIST

W electric wire
1 core wire
1a strand
10 crimp terminal
16 core-wire crimping section
18a large serration (first serration)
18b small serration (second serration)

1. A crimp terminal comprising a core-wire crimping section for crimping a core wire of an electric wire including a plurality of strands,
wherein first serrations are provided in a first region of the core-wire crimping section on a surface onto which the core wire is to be crimped, and
wherein second serrations smaller than the first serrations are provided in a second region of the core-wire crimping section on the surface onto which the core wire is to be crimped, and to which a crimping force larger than that in the first region is applied during a swaging and crimping process.

2. The crimp terminal according to claim 1, wherein the first serrations and the second serrations are circular recessed sections.
